(19) United States
(12) Patent Application Publication
(10) Pub. No.: US 2014/0110511 A1
(43) Pub. Date: Apr. 24, 2014

(54) REFINER PLATES WITH SHORT GROOVE SEGMENTS FOR REFINING LIGNOCELLULOSIC MATERIAL, AND METHODS RELATED THERETO

(71) Applicant: ANDRITZ INC., GLENS FALLS, NY (US)

(72) Inventor: Peter ANTENSTEINER, Lewisburg, PA (US)

(73) Assignee: ANDRITZ INC., GLENS FALLS, NY (US)

(21) Appl. No.: 14/044,145

(22) Filed: Oct. 2, 2013

Related U.S. Application Data
(60) Provisional application No. 61/715,398, filed on Oct. 18, 2012.

(51) Int. Cl. B02C 7/12; D21D 1/30

(52) U.S. Cl. CPC B02C 7/12; D21D 1/303
USPC 241/28; 241/298; 241/261.2; 241/261.3

(57) ABSTRACT

Refiner plate segments and refiner plates having fully dammed or partially dammed grooves on a major surface that may control flow behavior of lignocellulosic materials passing between refining plates in a refiner. The dammed grooves form groove segments, and each groove segment has a length of no more than about 30 mm or a subrange thereof.

### RELATED APPLICATION

This invention claims the benefit of U.S. provisional patent application 61/715,398, filed on Oct. 18, 2012, the entirety of which is incorporated herein by reference.

### BACKGROUND OF THE DISCLOSURE

The present disclosure generally relates to refiners, such as but not limited to disc refiners, conical refiners, cylindrical refiners, double disc refiners, double conical refiners, and double cylindrical refiners or similar equipment and their plates and plate segments, and more particularly to the shape of the bars and grooves that define the refining elements of these refiner plates or refiner plate segments.

Lignocellulosic material, e.g., wood chips, saw dust and other wood or plant fibrous material, is refined by mechanical refiners or similar equipment that separate fibers from the network of fibers that form the lignocellulosic material. Refiners for lignocellulosic material are fitted with refiner plates or refiner plate segments that are arranged to form a refiner filling. The refiner plates are also referred to as “discs.” In a refiner, two opposing refining surfaces (plates) are positioned such that at least one refiner plate rotates relative to the other refiner plate. In this respect, there may be one refiner plate that is held substantially stationary; this is generally called a “stator.” The other refiner plate that rotates is generally called a “rotor.”

The lignocellulosic material to be refined flows through a center inlet of one of the refiner plates and into a gap between the two refiner plates or surfaces. As one or both of the refiner plates rotate, centrifugal forces move the lignocellulosic material outwards through the gap and towards the periphery of the refiner plate.

The opposing refining surfaces of the refiner plates include annular sections having bars and grooves. The grooves provide passages through which material moves in a plane between the surfaces of the refiner plates. The lignocellulosic material also moves out of the plane from the grooves and over the bars. As the lignocellulosic material moves over the bars, the lignocellulosic material enters a refining gap between crossing bars of the opposing refiner plates. The crossing of bars apply forces to the lignocellulosic material in the refining gap that can act to separate the fibers in the lignocellulosic material. The repeated application of forces in the refining gap refines the lignocellulosic material into a pulp of separated and refined fibers, or exerts plastic deformation fibers to increase their bonding strength, or produces fines and shorter fibers, depending on the application.

Refiner plates for refining lignocellulosic material are known in the art, such as, for example, those described in U.S. Pat. Nos. 7,896,276; 7,712,694; and 6,032,888.

### BRIEF DESCRIPTION OF THE PREFERRED EMBODIMENTS

An embodiment of the disclosure may include a fully dammed refiner plate for mechanically refining lignocellulosic material in a refiner having opposing refiner plates. The fully dammed refiner plate comprises at least one refining zone on a major surface of the refiner plate, at least one type of grooves in the refining zone, and at least one full height dam in all or substantially all of the grooves. A full height dam is a dam situated in a groove such that the bottom of the dam is the substantially flat bottom surface of the groove, and the top of the dam is substantially the same height as the top of the bar or the surface of the refiner plate. The dammed grooves on the surface of the refiner plate form segments of grooves, and each groove segment has a length of no more than about 30 mm, about 25 mm, about 15 mm, about 10 mm, or about 5 mm. The terms “substantially” and “about” are used in this disclosure to refer to variations of between 5% to 10% or less.

Another embodiment may include a partially dammed refiner plate for mechanically refining lignocellulosic material in a refiner having opposing refiner plates. The partially dammed refiner plate comprises at least one refining zone on a major surface of the refiner plate, at least one type of grooves in the refining zone, and at least one full height dam in at least one of the grooves. The dammed grooves on the refiner plate form segments of grooves, each groove segment has a length of no more than about 30 mm, about 25 mm, about 15 mm, about 10 mm, or about 5 mm.

An exemplary method to use an embodiment of the present disclosure may include feeding lignocellulosic material into a refining gap between a set of opposing refiner plates from an inner edge of the refiner plates or surfaces, refining the lignocellulosic material between the set of specific refiner plates, and receiving refined lignocellulosic material on an outer edge of the refiner plates, wherein the lignocellulosic material is refined by refiner plates comprising at least one groove segment with a length of no more than about 30 mm.

Certain embodiments may also include two types of dammed grooves on the surface of the refiner plate. Other embodiments may also include having holes in the refiner plate to dewater the fiber flocks.

### BRIEF DESCRIPTION OF THE DRAWINGS

FIG. 1 is a drawing of a fully dammed refiner plate segment of a refiner plate;

FIG. 2 is a cross-sectional view of a first type of grooves that is substantially rectangular shaped;

FIG. 3 is a three-dimensional view of a first type of grooves that is substantially rectangular shaped;

FIG. 4 is a magnified view of a section of a fully dammed refiner plate;

FIG. 5 is a drawing of a partially dammed refiner plate segment of a refiner plate;

FIG. 6 is a cross-sectional view of a second type of grooves that is substantially trapezoidal shaped;

FIG. 7 is a three-dimensional view of a second type of grooves that is substantially trapezoidal shaped;

FIG. 8 is a magnified view of a section of a partially dammed refiner plate; and

FIG. 9 is a schematic drawing of a fully assembled refiner plate.

### DETAILED DESCRIPTION OF THE PREFERRED EMBODIMENTS

Refiner plate segments may be used, for example, in refining machines for refining low consistency (or high freeness) lignocellulosic material. Low consistency is generally less than 6% (by weight) solids content of the composition of the lignocellulosic material and liquid (slurry) being fed to the refiner, or even less than 5% or 2% (by weight) solid content of slurry. The refiner plate segments may also be used for medium consistency refining between about 6% to about 12% (by weight) solid content of the composition of the lignocellulosic material and liquid (slurry) being fed to the refiner. In certain aspects, the configuration of bars and grooves may be applied to various refiner geometries, e.g., disc refiners, conical refiners, double disc refiners, double conical refiners, cylindrical refiners, and double cylindrical refiners or similar equipment.

This disclosure relates to the belief that refiners (and the refiner plates used in refiners) may behave similar to centrifugal pumps, albeit inefficient ones, where the rotor is comparable to the impeller of a centrifugal pump, and where the stator acts like the so-called shroud of a pump (e.g., the space between impeller and pump housing).

Certain aspects of the present disclosure may be applicable to any refiner plate designs, including straight (or substantially parallel) bar designs and logarithmic spiral bar designs.

Conventionally, the vast majority of refiner plates use the same design on the rotor and the stator, which means that the shroud is formed like the pumping impeller. It is believed that the logarithmic spiral design for a refiner plate is hydraulically superior (e.g., a higher pressure increase at the same flow rate), an effect attributed to the radial nature of the logarithmic spiral geometry, neither technology (logarithmic spiral or straight designs) has attributed particular importance to the function and formation of the shroud (e.g., the stator) and its influence on the behavior of the hydraulic machine, the refiner, and the interaction between shroud (e.g., stator) and impeller (e.g., rotor).

This disclosure may relate to an insight derived from centrifugal pumps. Centrifugal pump designs have attributed importance to the flow behavior within the shroud. The term for these flows is “leakage”. The size and shape of the shroud (clearance) as well as the direction of the flow, play a role in the following items: (a) frictional losses causing (i) increased power consumption (e.g., comparable to the idle power of a refiner) and (ii) reduced pressure head (delta p, pressure increase across refiner), and (b) forces on the impeller, such as (i) impacting the forces to be consumed by the bearing and therefore influencing the design and safety factor of the bearing assembly and (ii) affecting the forces on the rotor in a low consistency refiner that influence the stability of the refining gap through the movement induced to the rotor (uneven refining in double disc refiners). For low consistency refiners these effects may present themselves as increased idle power, lower pressure increase and imbalanced refining action due to gap instability.

In an aspect, certain embodiments may optimize the hydraulic behavior of the refiner by optimizing the shroud of the pump and thereby optimizing the rotor-stator interaction of low consistency refiners with the intended benefits of one or more of (i) lower power consumption, (ii) better hydraulic efficiency (higher delta p), and (iii) improved gap stability by balancing the rotor in the case of double disc refiners.

With respect to centrifugal pumps, it is believed that the undisturbed inward flow through the shroud can be a major cause of negative effects. In pump housings, there may be a limited ability to respond to these negative effects, and efforts tend to focus on estimating its influence. For low consistency refiners, however, the shroud may influence performance and minimize negative effects related to inward flow of the material. The bars of the stator plate may act like the shroud in a centrifugal pump, rather than a smooth wall, therefore, the arrangement and design of the bars, while suitable for delivering the refining action, may also be used to influence the shroud performance. The same design and effect may be applicable to a medium consistency refiner.

Because it is believed that a root cause of poor performance issues may be the inward flow within the shroud of the pump, the present disclosure relates to minimizing prolonged stretches of open channels. The fluid should be prohibited from picking up speed in the grooves of the refiner plate. This may be accomplished by implementing a series of full height dams within each groove, as well as controlling the lengths of the grooves.

In certain embodiments, the rotor plate bar and groove pattern may be required for a different task in comparison to conventional rotor plates. Due to an increase in hydraulic performance, a reduction in energy consumption and better impeller balancing as a result of optimizing the stator, the rotor may now be designed to moderate and adjust the hydraulic potential of the refiner plate to the application. Three options may be available for this task: (i) a rotor plate that is fully dammed (which may be suitable for low flow requirements), (ii) a rotor plate that is partially dammed (which may be suitable for average flow requirements), and (iii) a rotor plate having no dams at all (which may be suitable for maximum flow requirements). The rotor plate with no dams at all may be substantially the same as the conventional refiner plates. In another embodiment, a stator plate may also be designed with the same three options for the rotor plate.

The rotor and stator designs may be used in a low consistency refiner wherein the pulp has a solid content less than 6% solid content of the composition of the lignocellulosic material and liquid (slurry) being fed to the refiner , or even less than 5% or 2% solid content of slurry. The designs may also be used in a medium consistency refiner that includes a fluid like medium, wherein the composition of the lignocellulosic material and liquid (slurry) being fed to the refiner pulp has a solid content of between about 6% to about 12%.

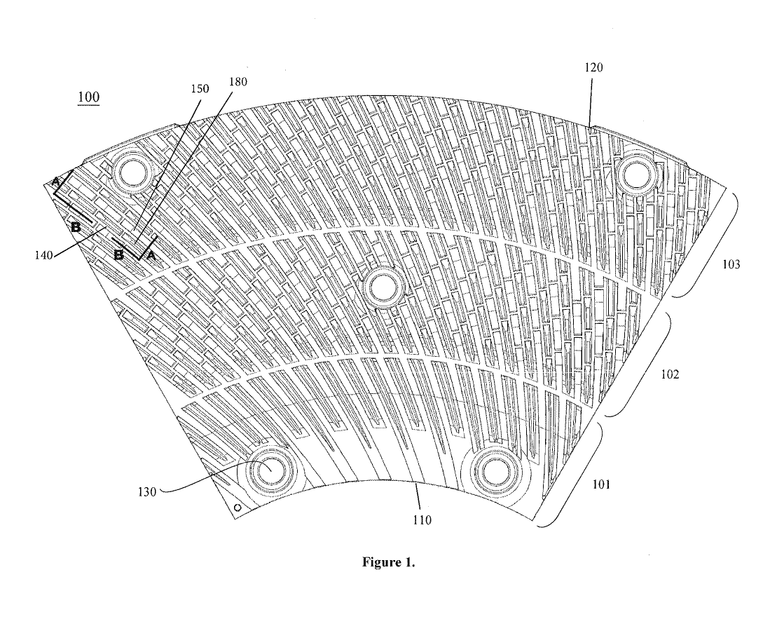

An embodiment of a dammed refiner plate segment 100 is shown in FIG. 1, wherein the refiner plate segment 100 has an inner edge 110, and an outer edge 120. The dammed refiner plate segment 100 also has a series of bolt holes 130 that enables the refiner plate segments to be operatively stabilized inside a refiner. The dammed refiner plate segment 100 has a feed zone 101, a first refining zone 102, and a second refining zone 103. A feed to be refined by the refiner plate would be fed from the inner edge 110 into the feed zone 101, progressing radially towards the outer edge 120.

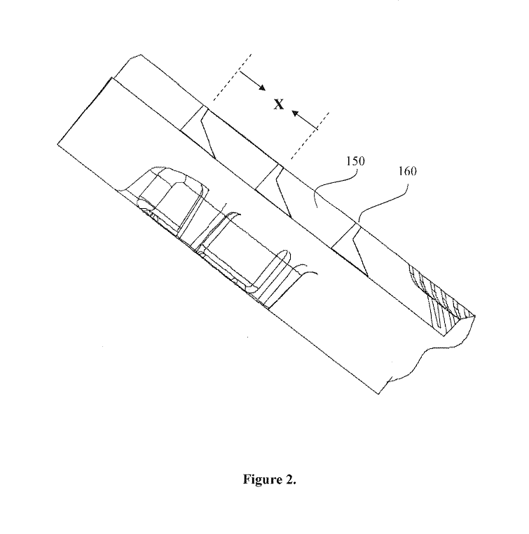

FIG. 1 shows an exemplary dammed refiner plate segment 100 of a refiner plate that comprises all or substantially all (e.g., more than 90% or 95%) of the grooves having at least one full height dam in the first refining zone 102, or the second refining zone 103, or both first refining zone 102 and second refining zone 103. In FIG. 1, a first type of dammed grooves is marked by line B, which is further detailed in a magnified, cross-sectional view in the direction of A in FIG. 2.

In an embodiment, a first groove type 150 is separated by dams 160, and have a length X (as shown in FIG. 2) of no more than about 30 mm, about 25 mm, about 15 mm, about 10 mm, or about 5 mm. A full height dam is a dam situated in a groove wherein the bottom of the dam is the substantially flat bottom surface of the groove, and the top of the dam is at substantially the same height as bar 140 or surface of the refiner plate segment. In this embodiment, two groove types, first groove type 150 and second groove type 180, and dams 160 are shown to be consecutively positioned in repeating patterns. Bars 140 are situated in between the lines of grooves (first groove type 150 and second groove type 180) and dams 160.

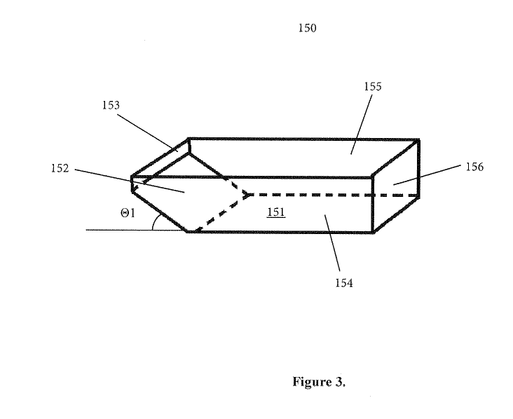

An embodiment of the first groove type 150 in three-dimensional view is shown in FIG. 3. The first groove type 150 may comprise a substantially flat bottom surface 151, and relative to the bottom surface 151, a sloped first short side 152 with a substantially vertical lip 153 on an edge of the sloped first short side 152 that is opposite from an edge abutting the bottom surface 151, a first substantially vertical long side 154, a second substantially vertical long side 155, and a substantially vertical short side 156. In an embodiment, the sloped first short side 152 may have an angle θ1 relative to the bottom surface 151. The angle θ1 may be no more than about 90 degrees, about 75 degrees, about 45 degrees, about 30 degrees, or about 15 degrees. A cross-section of first groove type 150 in the direction of B is in a substantially rectangular shape.

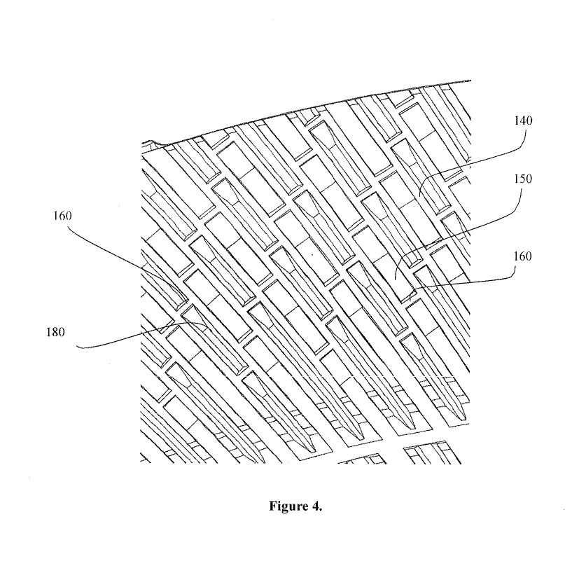

A magnified view of a section of the dammed refiner plate segment 100 is shown in FIG. 4. First groove type 150 and dams 160 are shown to be consecutively positioned in repeating patterns along logarithmic lines, forming logarithmic lines of grooves. Second groove type 180 and dams 160 are also positioned in a repeating pattern along logarithmic lines, parallel to the series of logarithmic lines of first groove type 150 and dams 160. Bars 140 are situated in between the logarithmic lines of grooves (first groove type 150 and second groove type 180).

An embodiment of the disclosure may include use of only one of the first groove type 150 or the second groove type 180 situated between dams 160 in logarithmic groove lines. The groove lines may also be in a straight line pattern with parallel bars 140. An additional embodiment of the disclosure may have an alternate repeating pattern wherein the first groove type 150 and the second groove type 180 are situated alternatively between dams 160, and along straight or logarithmic groove lines.

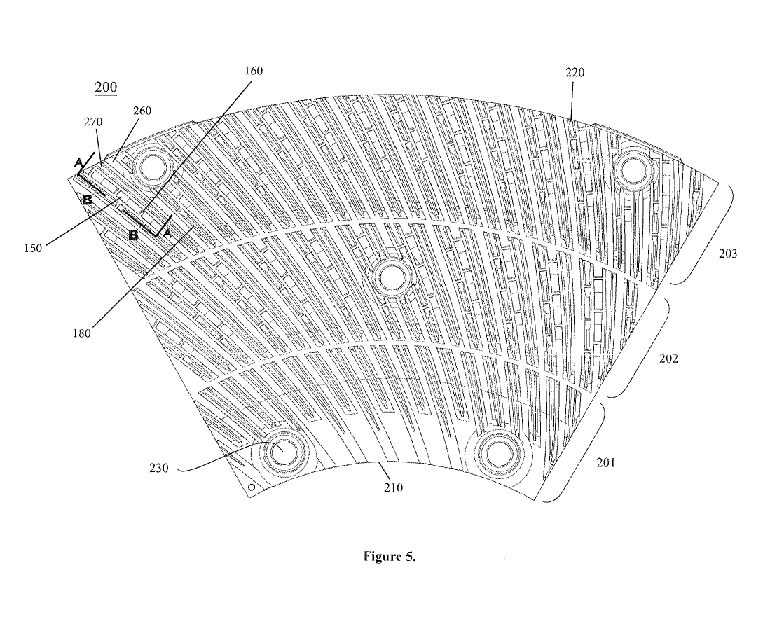

Another embodiment of the disclosure may be partially dammed, e.g., a partially dammed refiner plate segment 200 shown in FIG. 5 (similar items as in other figures have similar numbers). The partially dammed refiner plate segment 200 has an inner edge 210, and an outer edge 220. The partially dammed refiner plate segment 200 also has a series of bolt holes 230 that enables the refiner plate segments to be operatively stabilized inside a mechanical refiner. The partially dammed refiner plate segment 200 has a feed zone 201, a first refining zone 202, and a second refining zone 203. A feed being refined by the refiner plate would be fed from the inner edge 210 into the feed zone 201, progressing outwardly towards the radial peripheral outer edge 220.

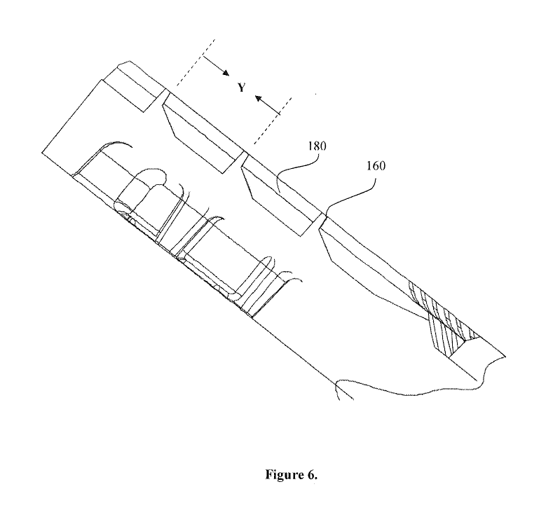

The exemplary partially dammed refiner plate segment 200 comprises partially dammed grooves (e.g., between about 10% to about 90% of the grooves are dammed, preferably between about 25% to about 75%, more preferably between about 35% to about 60%), undammed grooves in the first refining zone 202, and undammed grooves in the second refining zone 203. The dams, when present, are full height dams. In FIG. 5, the second groove type 180 is marked by line B, which is further detailed in a magnified, cross-sectional view in the direction of A in FIG. 6. In an embodiment, the second groove type 180 is separated by dams 160, and has a length Y (as shown in FIG. 6) of no more than about 30 mm, about 25 mm, about 15 mm, about 10 mm, or about 5 mm.

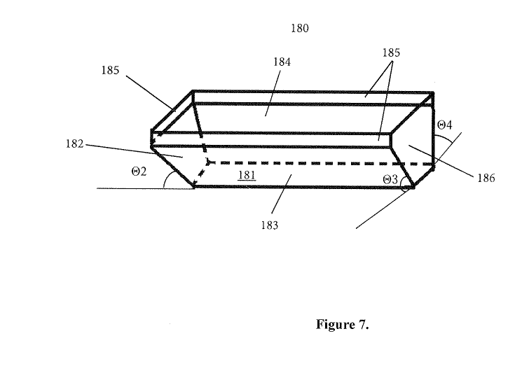

An embodiment of the second groove type 180 in three-dimensional view is shown in FIG. 7. The second groove type 180 may comprise a substantially flat bottom surface 181, and relative to the bottom surface 181, a sloped short side 182, a first sloped long side 183, a second sloped long side 184, and a substantially vertical lip 185 along the three sloped sides (182, 183, and 184) on an edge of each of the 3 sloped sides that is opposite from an edge of each of the sloped sides abutting the bottom surface 181. The second groove type 180 also comprises a substantially vertical short side 186.

In an embodiment, the sloped sides (182, 183 and 184) may have angles relative to each of the sloped sides: angle θ2 of the sloped first short side 182 relative to the bottom surface 181, angle θ3 of the first sloped long side 183 relative to the bottom surface 181, and angle θ4 of the second sloped long side 184 relative to the bottom surface 181. Each of the angles may be in similar or distinguishable degrees of slope of no more than about 90 degrees, about 75 degrees, about 45 degrees, about 30 degrees, or about 15 degrees. A cross-section of second groove type 180 in the direction of B may be in a substantially trapezoidal shape.

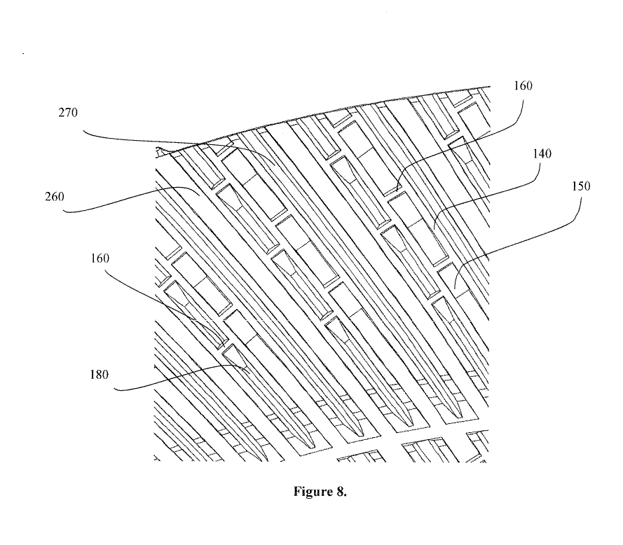

A magnified view of a section of the partially dammed refiner plate segment 200 is shown in FIG. 8. First groove type 150 and dams 160 are shown to be consecutively positioned in repeating patterns following a logarithmic shape. Second groove type 180 and dams 160 may also be present in this embodiment and may be consecutively position in repeating patterns following a logarithmic shape. Bars 140 are situated in between the logarithmic lines of grooves that include first groove type 150 with dams 160, and second groove type 180 with dams 160. A first undammed groove type 260 and a second undammed groove type 270 may be parallel to the groove lines that include first groove type 150, second groove type 180, and dams 160. The partially dammed refiner plate segment 200 may provide a faster flow rate than the substantially dammed refiner plate segment 100.

Alternatively, the design could consist of a series of holes drilled or cast into the refiner plate in the shape of, e.g., circles, rectangles, and triangles, to create recesses for dewatering of the fiber flocks in the refining process, while disallowing continuous inward flow through the stator. The holes may have a diameter or width of no larger than about 15 mm, about 10 mm, about 5 mm, about 3 mm, or about 2 mm.

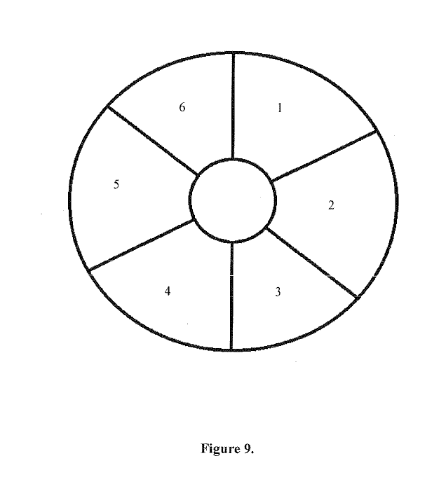

FIG. 9 shows a schematic drawing of a fully assembled refiner plate comprising six refiner plate segments. The refiner plate segments may be fully dammed or partially dammed refiner plate segments described above. Refiner plates may have greater or fewer segments forming the refiner plate, including, e.g., 2, 3, 4, 5, 6, 7, 8, 9, 10, 11, or 12 segments.

In certain aspects, this disclosure thus relates to alleviating a problem pertaining to rotor balancing in double disc refiners. This disclosure may also lead to lower energy consumption and improved hydraulics in refiners, e.g., low consistency refiners, and medium consistency refiners that includes a fluid medium.

The disclosure may relate to the special formation of the stator plate, which may be achieved by using dams on refiner plates at a spacing no longer than about 25 mm to about 30 mm apart or by using alternative stator designs yielding a design with groove segments no longer than about 25 mm to about 30 mm. The stator design may require a rotor to be adjusted to the hydraulic needs of the application, which may be achieved by using plate designs, e.g., fully dammed, partially dammed or regular refiner plate designs.

Aspects of this disclosure may allow for significant idle power energy reduction, may provide the tools for managing the hydraulic capacity of the rotor-stator combination, and may alleviate potential problems associated with the issue of rotor centering in double disc low consistency refiners.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Designs of the refiner plates and refiner plate segments are not limited to the embodiments described. Other embodiments may include substantially straight grooves and bars, and/or other combinations.

What is claimed is:

1. A dammed refiner plate segment for mechanically refining lignocellulosic material in a refiner having opposing refiner plates, the refiner plate segment comprising:
at least one refining zone;
multiple grooves in the at least one refining zone; and
multiple full height dams in all or substantially all of the grooves;
wherein the full height dams in all or substantially all of the grooves define groove segments between full height dams, the groove segments having a length of no more than about 30 mm.

2. The dammed refiner plate segment in claim 1, wherein the refiner plate segment comprises at least one groove segment having one short side defined by a first face of a first adjacent dam that is substantially rectangular, and having one sloped short side defined by a second face of a second adjacent dam.

3. The dammed refiner plate segment in claim 1, wherein the refiner plate segment comprises at least one groove segment having one short side defined by a face of a first adjacent dam that is substantially trapezoidal, and having one sloped short side defined by a face of a second adjacent dam.

4. The dammed refiner plate segment in claim 1, further comprising one or more holes drilled or cast into the refiner plate segment to create recesses for the dewatering of the fiber flocks in the refining process, the one or more holes have a diameter of no larger than about 15 mm.

5. The dammed refiner plate segment in claim 1, wherein the groves and dams are consecutively positioned in repeating patterns, and wherein grooves and dams form at least one of a straight line pattern with bars situated in parallel between the straight lines of grooves and dams, or form a logarithmic pattern with bars situated in between the logarithmic pattern of grooves and dams.

6. A partially dammed refiner plate segment for mechanically refining lignocellulosic material in a refiner having opposing refiner plates, the refiner plate segment comprising:
at least one refining zone;
multiple grooves in the at least one refining zone; and
at least two full height dams in at least one of the grooves;
wherein the full height dams define groove segments between the full height dams, and each groove segment has a length of no more than about 30 mm.

7. The partially dammed refiner plate segment in claim 6, wherein between about 10% to about 90% of the grooves in the refining zone include multiple full height dams.

8. The partially dammed refiner plate segment in claim 6, wherein the refiner plate segment comprises at least one groove segment having one short side defined by a first face of a first adjacent dam that is substantially rectangular, and having one sloped short side defined by a second face of a second adjacent dam.

9. The partially dammed refiner plate segment in claim 6, wherein the groves and dams are consecutively positioned in repeating patterns, and wherein the grooves and dams form at least one of a straight line pattern with bars situated in parallel between the straight lines of grooves and dams, or form a logarithmic pattern with bars situated in between the logarithmic pattern of grooves and dams.

10. The dammed refiner plate segment in claim 6, wherein the refiner plate segment comprises at least one groove segment having one short side defined by a face of a first adjacent dam that is substantially trapezoidal, and having one sloped short side defined by a face of a second adjacent dam.

11. The dammed refiner plate segment in claim 6 further comprising a series of holes drilled or cast into the refiner plate segment to create recesses for the dewatering of the fiber flocks in the refining process, the holes have a diameter of no larger than about 15 mm.

12. A refiner plate for mechanical refining of lignocellulosic materials comprising:
multiple refiner plate segments operatively attached to form a circular shape;
wherein the refiner plate segments each comprise bars, grooves, and multiple full height dams in the grooves to define groove segments between two full height dams; and
wherein at least one of the groove segments has a length of no more than about 30 mm.

13. The refiner plate in claim 12, wherein grooves on the refiner plate segments of the refiner plates are one of substantially dammed by full height dams, or partially dammed by full height dams.

14. The refiner plate in claim 13, wherein a partially dammed refiner plate segment comprises groove segments defined by two full height dams, and between about 10% to about 90% of the grooves in the refining zone includes multiple full height dams.

15. The refiner plate of claim 12, wherein the grooves, dams, and bars are consecutively positioned in repeating patterns, and wherein grooves and dams form at least one of a straight line pattern with bars situated in parallel between the straight lines of grooves and dams, or form a logarithmic pattern with bars situated in between the logarithmic pattern of grooves and dams.

16. A method of mechanically refining lignocellulosic material in a refiner having opposing refiner plates, the steps comprising:
feeding lignocellulosic material into a refining gap between a set of opposing refiner plates through an inner edge of the refiner plates, wherein the set of refiner plates includes at least one refiner plate comprising at least one refiner plate segment, the refiner plate segment comprising at least one groove segment defined by two full height dams with a length of no more than about 30 mm.
refining the lignocellulosic material between the set of refining plates; and
receiving refined lignocellulosic material from an outer edge of the refiner plates.

17. The method in claim 16, wherein grooves on at least one of the opposing refiner plates are one of substantially dammed by full height dams, or partially dammed by full height dams.

18. The method in claim 17, wherein the partially dammed refiner plate segment comprises between about 10% to about 90% of the grooves in the refining zone that include multiple full height dams.

19. A mechanical refiner to refine lignocellulosic materials having opposing refiner plates, the refiner comprising:
a rotor refiner plate; and
a stator refiner plate with a major surface opposing the rotor refiner plate;
wherein one of the rotor refiner plate and the stator refiner plate comprises at least one refiner plate segment, and the refiner plate segment comprises at least one groove segment at a length of no more than about 30 mm.

20. The mechanical refiner in claim 19, wherein grooves on the refiner plate segments are one of substantially dammed by full height dams, or partially dammed by full height dams.

21. The mechanical refiner in claim 20, wherein a partially dammed refiner plate segment comprises groove segments defined by two full height dams, and between about 10% to about 90% of the grooves in the refining zone includes multiple full height dams.
